(19) United States
(12) Patent Application Publication
(10) Pub. No.: US 2014/0026861 A1
(43) Pub. Date: Jan. 30, 2014

(54) METHOD AND DEVICE FOR CONTROLLING AN ADJUSTING UNIT FOR A VARIABLE COMPRESSION RATIO

(71) Applicants: Martin Bechtold, Stuttgart (DE); Jochen Betsch, Waiblingen (DE); Klaus Fieweger, Kirchheim (DE); Gerd Kroener, Aspach-Grossaspach (DE); Markus Lengfeld, Leutenbach (DE); Alexander Scheindlin, Stuttgart (DE); Dietmar Schroeer, Weissach im Tal (DE); Georg Seidel, Stuttgart (DE)

(72) Inventors: Martin Bechtold, Stuttgart (DE); Jochen Betsch, Waiblingen (DE); Klaus Fieweger, Kirchheim (DE); Gerd Kroener, Aspach-Grossaspach (DE); Markus Lengfeld, Leutenbach (DE); Alexander Scheindlin, Stuttgart (DE); Dietmar Schroeer, Weissach im Tal (DE); Georg Seidel, Stuttgart (DE)

(73) Assignee: DAIMLER AG, Stuttgart (DE)

(21) Appl. No.: 14/110,505

(22) PCT Filed: Dec. 8, 2011
(86) PCT No.: PCT/EP2011/006164

§ 371 Date: Oct. 17, 2013

(30) Foreign Application Priority Data
Apr. 15, 2011 (DE) 10 2011 017 171.1
Apr. 15, 2011 (DE) 10 2011 017 173.8
Apr. 15, 2011 (DE) 10 2011 017 174.6
Apr. 15, 2011 (DE) 10 2011 017 215.7
Apr. 15, 2011 (DE) 10 2011 017 229.7
May 12, 2011 (DE) 10 2011 101 336.2

(51) Int. Cl. F02B 75/04

(52) U.S. Cl. CPC F02B 75/04
USPC 123/48 R; 701/102

(57) ABSTRACT

An internal combustion engine for a motor vehicle, having at least one adjusting device by means of which at least one compression ratio of the internal combustion engine is variably settable. At least one detection device is provided by means of which at least one signal (20, 22) which characterizes an actuation effort for setting the compression ratio is detectable. The invention further relates to a method for checking an adjusting device of such an internal combustion engine.

The invention relates to an internal combustion engine for a motor vehicle of the type stated in the preamble of claim 1, and a method for checking an adjusting device for variably setting a compression ratio of an internal combustion engine of the type stated in the preamble of claim 5.

EP 1 307 642 B1 discloses a reciprocating piston internal combustion engine having a piston which is displaceably situated in a cylinder. The piston is articulatedly coupled to a connecting rod, the movement of which is transmittable to a crank of a crankshaft. A transmission member is provided between the connecting rod and the crank, the movement of the transmission member being manipulable by a control lever for the purpose of ensuring controllable movement of the piston. In particular, the aim is to enable variation of the compression ratio and the piston stroke. The transmission member is designed as a transverse lever which is coupled to the crank via an articulated joint, this articulated joint being situated in the area between a bearing point of the transverse lever for the control lever, and a bearing point of the transverse lever for the connecting rod. The articulated joint is situated between the transverse lever and the crank at a distance from the connecting line between the two bearing points of the transverse lever for the control lever and for the connecting rod, respectively.

It is provided that the lateral length between the control lever bearing point and the connecting rod bearing point and the lateral length between the control lever bearing point and the crank articulated joint point are designed in a specific manner regarding their dimensions, in relation to the crank radius.

A method for diagnostic operation of an internal combustion engine is known from DE 102 51 493 A1. The internal combustion engine has multiple compression ratio operating states. In the method, a change in the ignition adjustment is determined which is necessary for avoiding knocking when the engine is operated in certain compression ratio operating states. In addition, the operation, i.e., the state of the internal combustion engine, is assessed based at least partially on the change in the ignition adjustment.

A method for function monitoring of a device for variably setting the cylinder compression in a reciprocating piston internal combustion engine is known from DE 199 55 250 A1. In the cited document, it is provided that both before and after a control of the device for changing the cylinder compression, an engine operating parameter which responds to a change in the cylinder compression is ascertained, and that both values of the engine operating parameter are compared to one another to determine whether a change in the engine operating parameter has occurred. A change in the engine operating parameter represents an indication of correct functioning of the device for variably setting the cylinder compression, This method has further potential for providing better checking of the functioning of the adjusting device.

The object of the present invention, therefore, is to provide an internal combustion engine for a motor vehicle and a method for checking an adjusting device of such an internal combustion engine, by means of which improved checking of the adjusting device for setting the compression ratio is made possible.

This object is achieved by an internal combustion engine for a motor vehicle having the features of claim 1, and by a method for checking an adjusting device of such an internal combustion engine, having the features of claim 5. Advantageous embodiments together with practical and nontrivial refinements of the invention are set forth in the remaining claims.

The first aspect of the invention concerns an internal combustion engine for a motor vehicle, having at least one adjusting device. At least one compression ratio of the internal combustion engine is variably settable by means of the adjusting device.

According to the invention, at least one detection device is provided by means of which at least one signal which characterizes an actuation effort to be expended by the adjusting device, or an actual energy quantity to be expended for setting the compression ratio, is detectable for setting the compression ratio. It is thus possible to detect the actuation effort for setting or adjusting the compression ratio, or the actual energy quantity to be expended, as the actual actuating effort. This detection allows an actual state, in particular with regard to wear, of the adjusting device to be ascertained with a high level of quality and a high level of informative value. Better, extremely precise conclusions regarding the instantaneous, actual state of the adjusting device may be drawn in this way. A particularly precise on-board diagnostics (OBD) system of the motor vehicle is thus possible. As a result, conclusions may be drawn regarding any undesirable malfunction, or that the adjusting device for setting the compression ratio does not have, or no longer completely has, its desired optimal functionality, so that the compression ratio cannot be set, or cannot be set with as high a degree of precision as would be possible without the wear of the adjusting device.

If an undesirable state of the adjusting device, for example an undesirable wear of same, is ascertained, appropriate countermeasures may be initiated. One of these measures may be, for example, information which is communicated to a user, in particular a driver, of the motor vehicle in the form of a visually and/or acoustically perceivable signal or the like. The undesirable state of the adjusting device may thus be communicated to the user of the motor vehicle, who, for example, may be induced to visit a repair shop and/or to service, repair, and/or replace the adjusting device.

If the ascertained state of the adjusting device is a desired state thereof in which the adjusting device is able to meet its desired function for setting the compression ratio, this may also be appropriately communicated to the user.

Alternatively or additionally, it is possible to store the corresponding state of the adjusting device in a memory device of the internal combustion engine, in particular the detection device. Thus, for example, development over time of the state of the adjusting device may be documented and understood.

In the internal combustion engine having the adjusting device, which is designed as a so-called multilink drive mechanism, for example, during operation of the internal combustion engine, in particular as a function of load points of same, very high actuating forces and/or actuating torques may result which must be applied by the adjusting device, in particular by a mechanism which includes gearing and/or an actuator, for example, in order to set or adjust the compression ratio. These high actuating forces and/or actuating torques, which characterize, for example, the actuation effort for setting the compression ratio, may represent high loads for the adjusting device. It may thus be possible that the adjusting device in particular undergoes wear over a very long service life of the internal combustion engine, and the actuation effort for setting the compression ratio becomes greater over the service life. In other words, the setting or adjustment of the compression ratio becomes more difficult.

This may result from higher friction, for example in bearings, gearwheels, and/or other types of force and/or torque transmission elements of the adjusting device, than is the case for a state of the adjusting device with little or no wear. As a result, it is possible that the adjusting device may no longer be able to meet required adjustment dynamics, i.e., a speed at which the compression ratio may be set or adjusted. Particularly severe wear of the adjusting device may possibly result in its failure. Such failure may have an adverse effect on pollutant emissions from the internal combustion engine if no appropriate countermeasures are taken. In other words, this means that the internal combustion engine may have undesirably high pollutant emissions.

In the internal combustion engine according to the invention, the situation may now be avoided in which the adjusting device is operated when it can no longer meet the required, desired adjustment dynamics, and thus has an undesirable state. This is the case since due to the detection device and the detection of the state of the adjusting device, the undesirable state and thus the increased wear, which may adversely affect the adjustment dynamics of the adjusting device, is detectable. In particular, a boundary state, for example, is detectable in which the adjusting device still meets the desired, required adjustment dynamics, but from which it may be concluded that within a certain time period, starting from the boundary state, the adjusting device will have a state in the future in which it can no longer meet the adjustment dynamics.

It is thus possible for the adjusting device to be serviced, repaired, and/or replaced before the undesirable state is reached in which the adjusting device can no longer have the desired, required adjustment dynamics, and in particular prior to an imminent or probable failure.

This is thus accompanied by avoidance of the undesirable increase in pollutant emissions and the increase in fuel consumption of the internal combustion engine. It may thus be ensured that the internal combustion engine may be adjusted particularly efficiently, even over its long service life, by setting the compression ratio at different operating points, and may thus be operated with low fuel consumption and low CO₂ emissions.

In one advantageous embodiment of the invention, by means of the detection device, which is associated, for example, with a control and/or regulation device of the internal combustion engine, the detected signal may be compared to a predefinable setpoint value, setpoint signal, or the like. The setpoint value and/or the setpoint signal, wherein only “setpoint signal” is used below for either term, may be stored, for example, in a memory device of the detection device, in particular in the form of a characteristic map. It is thus possible to compare the signal, detected as the actual signal, to the setpoint signal. If the comparison shows that the actual signal deviates from the setpoint signal, and, for example, the deviation exceeds a predefinable threshold value or a predefinable threshold signal, an undesirable state, for example the boundary state, of the adjusting device may be deduced, and this state may be ascertained. This comparison allows a particularly precise and meaningful determination of the instantaneous, actual state of the adjusting device. Thus, the adjusting device in particular may be serviced and/or repaired and/or replaced only when this is actually necessary. Unneeded service and/or repair operations may thus be avoided.

The setpoint signal to be compared to the detected actual signal relates to the same predeterminable defined state of the internal combustion engine when the adjusting device has little or no wear. This setpoint signal is ascertained, for example, in such a way that the compression ratio is adjusted in the defined state; the actual actuating effort for this purpose is ascertained when the internal combustion engine is still in its new state. In other words, the setpoint signal is detected or ascertained at least essentially directly after manufacture of the internal combustion engine and/or the motor vehicle. It is likewise possible for the setpoint signal to be detected or ascertained in some other way. It may be provided that the setpoint signal is ascertained and/or computed for example within the scope of development of the internal combustion engine. An undesirable state due to increased wear of the adjusting device, for example, may thus be deduced in a particularly precise manner.

In one particularly advantageous embodiment of the invention, by means of the detection device at least one torque and/or at least one variation of torque over time, and/or at least one force and/or at least one variation of force over time, is/are detectable as the signal which characterizes the actuation effort for setting the compression ratio. The adjusting device has a rotatable shaft, for example. For setting or adjusting the compression ratio, for example a torque is introduced into the adjusting shaft by an actuator, in particular an electric motor, of the adjusting device. By means of the detection device, which may include a torque sensor and/or a strain gauge device, for example, the introduced torque, which is necessary for setting or adjusting the compression ratio and is to be applied by the actuator, is detected as the actual torque, at least in terms of magnitude. The actual torque may subsequently be compared to a setpoint torque as the setpoint signal. If the actual torque, at least in terms of magnitude, is greater than the setpoint torque, for example increased wear and thus a corresponding state, in particular the boundary state, of the adjusting device may be deduced, and this state may be ascertained.

Additionally or alternatively, it is possible to carry out the detection using some other type of transmission element for transmitting forces and/or torques for setting the compression ratio. It may also be provided that for setting or adjusting the compression ratio, this transmission element of the adjusting device is at least essentially translationally movable. A force and/or a variation of force over time, for example, which is to be applied for setting the compression ratio and thus for moving the adjusting element, is then detectable as the actual signal by means of the detection device,

A very precise and meaningful measurement, evaluation, and diagnosis of the adjusting is thus possible, so that an assessment of the instantaneous state of the adjusting device may be made. For example, wear and/or friction and/or the presence of play, in particular between the transmission elements, of the adjusting device may be deduced. As a result, countermeasures may then be taken early to avoid an error or an error message of the on-board diagnostics system, as well as an undesirable malfunction of the adjusting device.

In another advantageous embodiment of the invention, the adjusting device includes at least one electric motor for setting the compression ratio. The electric motor includes, for example, a rotationally and/or translationally movable moving part by means of which the setting of the compression ratio is achievable. It is provided that an electrical current consumption of the electric motor is detectable by means of the detection device as the signal which characterizes the actual energy quantity to be expended for setting the compression ratio. It is likewise possible that a variation over time of the current consumption is detectable as the signal. The instantaneous, actually present or provided state of the adjusting device may be deduced particularly reliably, and at least essentially directly, based on the current consumption. In addition, the state may be ascertained in a particularly simple and cost-effective manner, at least essentially without additional sensors.

It may advantageously be provided that the setpoint energy quantity to be expended for setting the compression ratio as a function of an electrical current consumption of the electric motor, computed based on a model, is computable by means of the computing unit. This also allows the particularly precise and meaningful ascertainment of the instantaneous, actually present state of the adjusting device, so that undesirably high pollutant emissions as well as undesirably high fuel consumption of the internal combustion engine are avoidable. A variation over time of the current consumption may also be computed based on the model.

For ascertaining the state of the internal combustion engine, for example the detected current consumption is compared to the computed current consumption. If, as described above, this comparison shows that the actual energy quantity deviates from the setpoint energy quantity and the deviation is above or below a predefinable threshold value, an undesirable state of the adjusting device or the boundary state thereof may be deduced. As a result, suitable countermeasures may be initiated to avoid the failure and/or undesirable impairment of the functionality of the adjusting device, and to prevent this, optionally by service and/or repair operations.

The second aspect of the invention concerns a method for checking an adjusting device for variably setting at least one compression ratio of an internal combustion engine for a motor vehicle, in particular a passenger motor vehicle. A state of the adjusting device is ascertained in the method.

The method according to the invention is characterized in that a signal which characterizes the actual energy quantity to be expended for setting the compression ratio is detected by means of at least one detection device. In addition, the actual energy quantity is ascertained based on the detected signal, using at least one computing unit. Furthermore, a setpoint energy quantity to be expended for setting the compression ratio is computed based on a model which simulates at least one physical property of the internal combustion engine. Advantageous embodiments of the first aspect of the invention are regarded as advantageous embodiments of the second aspect of the invention, and vice versa.

The method according to the invention allows improved checking of the adjusting device, and the particularly precise and meaningful ascertainment of the instantaneous, actually present state of the adjusting device. By means of the method according to the invention, the adjusting device may be rapidly and cost-effectively checked for setting the compression ratio, in particular with regard to its functionality.

If an undesirable state, or a state of the adjusting device starting from which an undesirable state of the adjusting device will be present in the near future, is ascertained, appropriate countermeasures may thus be initiated early to prevent the adjusting device from going into the undesirable state, and/or to prevent the adjusting device or at least one transmission element thereof from failing or malfunctioning.

The actual energy quantity is compared to the setpoint energy quantity, the state of the adjusting device being ascertained based on this comparison. A particularly precise ascertainment of the instantaneous, actually present state of the internal combustion engine is thus made possible. In addition, the state may thus be ascertained in a particularly simple and cost-effective manner with only a small number of parts. This keeps the weight as well as the costs of the internal combustion engine particularly low.

If the comparison shows that the actual energy quantity, at least in terms of magnitude, is less than the setpoint energy quantity, for example a failure or a malfunction of at least one force and/or torque transmission element associated with the adjusting device for setting the compression ratio is thus ascertained. In other words, if the actual energy quantity is less than the setpoint energy quantity, the likelihood is particularly great that this is due to the malfunction or the failure of at least one corresponding transmission element of the adjusting device.

This result of the comparison indicates, for example, that an actuating force and/or an actuating torque for setting the compression ratio which, for example, is expended by the electric motor of the adjusting device, is not, or is not completely, transmitted to a piston situated in a combustion chamber, in particular a cylinder, of the internal combustion engine in order to set the compression ratio by moving this piston relative to the combustion chamber inside the combustion chamber. Due to this ascertainment of the malfunction or failure, appropriate countermeasures may be initiated to avoid operation of the internal combustion engine, resulting from the failure, with undesirably high fuel consumption and/or undesirably high pollutant emissions.

If the comparison of the actual energy quantity to the setpoint energy quantity shows that the actual energy quantity, at least in terms of magnitude, is greater than the setpoint energy quantity, increased friction and/or some other type of impairment of the functionality of the adjusting device may be deduced, for example, if at least one transmission element of the adjusting device is jammed or otherwise impaired in its function. In this case as well, appropriate countermeasures must be initiated particularly early to avoid the undesirable state, in particular the operating state, of the internal combustion engine.

For particularly precise and meaningful ascertainment of the instantaneous state of the adjusting device, in one embodiment of the invention it may be provided that the detected signal is compared to a setpoint signal which characterizes a setpoint movement of the adjusting element when the adjusting device is supplied with the predefinable quantity of energy. The setpoint signal is stored, for example, in a memory device of the adjusting device, and characterizes the movement of the adjusting element when there is at least essentially little or no wear of the adjusting device. The setpoint signal is ascertained, for example, at least directly after manufacture of the adjusting device or the internal combustion engine, for example by detecting the setpoint signal by means of an appropriate detection device. Alternatively or additionally, it may be provided that the setpoint signal is computed within the scope of development of the internal combustion engine or the adjusting device. Thus, in this method the movement of the adjusting element due to supplying the adjusting device with the predefinable quantity of energy is compared to the setpoint movement. The setpoint movement occurs when the adjusting device has little or no wear.

If the comparison of the signal, as an actual signal, to the setpoint signal shows that the actual signal deviates from the setpoint signal, it may be concluded that a malfunction and/or a circumstance which at least essentially impairs the optimum, desired functionality of the adjusting device is present. This circumstance may be, for example, the previously described undesirably high friction due to wear of the adjusting device. It is thus apparent that the state, as well as a development over time of the state, of the adjusting device is ascertainable in a very precise and meaningful manner by means of the method according to the invention.

In one particularly advantageous embodiment of the invention, a signal which characterizes a rotary motion, in particular a rotation angle and/or a rotational speed, of the adjusting element about a corresponding rotational axis due to supplying the adjusting device with the predefinable quantity of energy is detected as the signal (actual signal). The state of the adjusting device may thus be deduced in a particularly precise and meaningful manner. If the adjusting element, due to its rotation, has a rotational speed and/or a rotation angle which is/are less than a rotational speed and/or a rotation angle for the setpoint movement, this represents an indication of the presence of increased friction with respect to the setpoint movement, and thus increased wear of the adjusting device. Appropriate countermeasures may then be initiated and taken particularly early to avoid further wear of the adjusting device or to keep the wear within narrow limits. The adjusting device may thus be prevented from reaching the undesirable state.

In one advantageous embodiment of the invention, a variation over time of a variable or value of the adjusting element which characterizes the actuation effort for setting the compression ratio is detected as the signal. This variable or this value allows the state of the adjusting device to be ascertained in a particularly precise and meaningful manner Any measurement errors of the detection device during detection of the signal may thus be identified and compensated for if necessary. In other words, very good quality of the signal is achievable in this embodiment.

In one particularly advantageous embodiment of the second aspect of the invention, a variation over time of an electrical current consumption of the electric motor associated with the adjusting device for setting the compression ratio is detected as the signal. In this regard, the current consumption is used as a measure of the actuation effort. In this way, the signal may be detected in a particularly simple and cost-effective manner, and in particular without additional costly and space-consuming sensors, so that the state of the adjusting device may be deduced.

Thus, in one particularly advantageous embodiment of the invention it is provided that the variation over time of the variable or the value which characterizes the actuation effort for setting the compression ratio is divided into a first range which characterizes the static friction state of the adjusting device, and at least one second range which characterizes the sliding friction state of the adjusting device.

The adjusting device includes, for example, at least one transmission element by means of which forces and/or torques for setting the compression ratio are transmittable. For setting the compression ratio, the transmission element is, for example, supported on a component, in particular a housing, of the internal combustion engine or of the adjusting device via at least one bearing so as to be rotationally and/or translationally movable. The bearing may include two bearing parts which are movable relative to one another for allowing a motion of the transmission element relative to the component or the housing.

Two elements which are initially at rest relative to one another, such as the two bearing parts, and which subsequent to this rest are moved relative to one another, are characterized, in particular when they are to be lubricated with a lubricant such as lubricating oil, in that for transferring the parts (the bearing parts) from the rest state into relative motion, a static friction state must first be overcome. After overcoming the static friction state in which static friction is present between the bearing parts, when the bearing parts move relative to one another a sliding friction state is present in which sliding friction is present. For overcoming the static friction state and transferring same into the sliding friction state, it is necessary to apply so-called breakaway forces and/or breakaway torques. Since the static friction is greater than the sliding friction, the breakaway forces and/or the breakaway torques, at least in terms of magnitude, are greater than forces and/or torques which are to be applied in order to keep the bearing parts in relative motion with respect to one another (once they are transferred into this relative motion with respect to one another).

This is the case in particular for bearings, in particular slide bearings, which are lubricated with the lubricant, in particular lubricating oil, together with corresponding bearing parts as the bearing parts. Likewise, this is the case, for example, for gear teeth of two gearwheels, in particular of the adjusting device, which are engaged with one another.

Depending on the actuating forces and/or actuating torques to be applied in the static friction state, and depending on the actuating forces and/or actuating torques subsequently resulting in the sliding friction state, in which in particular at least essentially constant actuating forces and/or actuating torques result which are composed, for example, predominantly of frictional forces and/or frictional torques and which are a function of the state of the adjusting device, a particularly precise and reliable assessment may be made of the state of the adjusting device. In other words, the instantaneous, actually present state of the adjusting device may thus be ascertained in a particularly precise and meaningful manner.

In another advantageous embodiment of the method, the actual energy quantity is compared to the setpoint energy quantity, the state of the adjusting device being ascertained based on this comparison. A particularly precise ascertainment of the instantaneous, actually present state of the internal combustion engine is thus made possible. In addition, the state may thus be ascertained in a particularly simple and cost-effective manner with only a small number of parts. This keeps the weight and the costs of the internal combustion engine particularly low.

If the comparison shows that the actual energy quantity, at least in terms of magnitude, is less than the setpoint energy quantity, for example a failure or a malfunction of at least one force and/or torque transmission element associated with the adjusting device for setting the compression ratio is ascertained. In other words, if the actual energy quantity is less than the setpoint energy quantity, the likelihood is particularly great that this is due to the failure or malfunction of at least one corresponding transmission element of the adjusting device.

This result of the comparison indicates, for example, that an actuating force and/or an actuating torque for setting the compression ratio, which is expended, for example, by the electric motor of the adjusting device, is not, or is not completely, transmitted to a piston situated in a combustion chamber, in particular a cylinder, of the internal combustion engine in order to set the compression ratio by moving this piston relative to the combustion chamber inside the combustion chamber. As a result of this ascertainment of the malfunction or failure, appropriate countermeasures may be initiated to avoid operation of the internal combustion engine, due to the failure, with undesirably high fuel consumption and/or undesirably high pollutant emissions.

If the result of the comparison of the actual energy quantity to the setpoint energy quantity shows that the actual energy quantity, at least in terms of magnitude, is greater than the setpoint energy quantity, increased friction and/or some other type of impairment of the functionality of the adjusting device may be deduced, for example if at least one transmission element of the adjusting device is jammed or otherwise impaired in its function. In this case as well, appropriate countermeasures must be taken particularly early to avoid the undesirable state, in particular the operating state, of the internal combustion engine.

In one advantageous embodiment of the invention, the method is carried out after a deactivation of the activated internal combustion engine is triggered. This involves, for example, a so-called overrun mode of a control unit for controlling and/or regulating the internal combustion engine. In this overrun mode, the internal combustion engine has a defined state in which no combustion processes take place in combustion chambers of the internal combustion engine, and thus, no forces and/or torques due to combustion processes act on the adjusting device. Therefore, the signal to be detected is not influenced by other effects. The signal to be detected then characterizes, at least essentially directly, the state of the adjusting device without other influences. It is understood, however, that the method according to the invention may also be carried out in other defined states of the internal combustion engine in order to precisely and meaningfully ascertain the state of the adjusting device.

The method according to the invention may be carried out in particular when the internal combustion engine is in an unfired coasting mode state. This means that no combustion processes take place in the at least one combustion chamber of the internal combustion engine. In the coasting mode state, however, the internal combustion engine is driven by at least one rotating wheel of the motor vehicle. In addition, influences, in particular forces and/or torques, which may result from the combustion processes in the combustion chamber may thus be avoided.

In one particularly advantageous embodiment of the invention, the method is carried out when the internal combustion engine is a nondriven operating state. This means that no combustion processes take place in the combustion chamber. In addition, the internal combustion engine is also not driven, for example, by a moving wheel of the motor vehicle. This means that the piston in the combustion chamber, in particular in the cylinder, is not moved relative to the combustion chamber. This nondriven operating state is, for example, a deactivated operating state of the internal combustion engine. However, components associated with the internal combustion engine, for example at least one regulating device for controlling and/or regulating the internal combustion engine and/or the adjusting device, may be at least essentially activated in order to be able to carry out the method according to the invention.

Carrying out the method according to the invention in the nondriven operating state of the internal combustion engine has the advantage that influences, in particular forces and/or torques, resulting from combustion processes or from a motion of the piston relative to the combustion chamber inside the combustion chamber cannot adversely affect the ascertainment of the state or the detection of the signal which characterizes the state. The actual, instantaneously present state of the adjusting device is thus ascertainable in a particularly precise and meaningful manner.

Incorrect measurements as well as erroneous conclusions regarding the state of the adjusting device may thus be avoided. The described countermeasures for avoiding or eliminating the undesirable state of the adjusting device may thus be carried out in particular as needed, and only when this is actually necessary, i.e., when the adjusting device actually also has the corresponding state which triggers the countermeasures.

If the method is carried out when the motor vehicle is at a standstill, this has the advantage that in particular negative influences on the ascertainment of the state of the adjusting device resulting from a movement of the motor vehicle may be avoided. These influences resulting from a movement of the motor vehicle may be, for example, relative motions, vibrations, or the like of structural components or of the motor vehicle, and in particular of the internal combustion engine and of the adjusting device. This allows particularly precise ascertainment of the state of the adjusting device with all of the associated advantages.

Carrying out the method for at least one predefinable trigger event is advantageous, since the method is thus carried out under particularly defined conditions.

The method is advantageously carried out multiple times over the service life of the adjusting device. When the method is always carried out for at least essentially the same trigger event, it may thus be ensured, at least practically all the time, that at least approximately the same, defined conditions, and thus also influences on the ascertainment of the state, are present when the method is carried out. At least a plurality of results, i.e., states which are obtained by the method according to the invention, may be meaningfully and reliably compared to one another. For example, a variation over time of the state of the adjusting device over a certain time period may thus be ascertained, stored, documented, and evaluated.

In a further step of the method, it is provided that the method is carried out when the internal combustion engine is in a fired operating state. This means that combustion processes take place in at least one combustion chamber, in particular a cylinder, of the internal combustion engine.

As the result of carrying out the method according to the invention in the fired operating state of the internal combustion engine, the method is carried out under defined, and thus known, conditions. This means that defined, known influences, in particular resulting from forces and/or torques from the combustion processes, act on the adjusting device and thus on the ascertainment of its state. Since these influences are known, and are always at least essentially the same when the method is carried out multiple times, the quality and the informative value of the detected signal for ascertaining the state are not adversely affected. Instead, based on the detected signal, the state of the adjusting device may be deduced in a particularly precise manner and with a high level of quality.

In one particularly advantageous embodiment of the invention, the method is carried out when the internal combustion engine is operated in a predefinable speed range, in particular at a predefinable speed. The method is thus carried out in a defined, known operating state of the internal combustion engine in which effects which influence the ascertainment of the state of the adjusting device are known. Accordingly, the ascertainment of the state is at least essentially not adversely affected, so that the state of the adjusting device may thus be deduced in a particularly precise and meaningful manner. The predefinable speed range is, for example, the idle speed when the internal combustion engine is at operating temperature.

In another advantageous embodiment of the invention, the method is carried out when the internal combustion engine is operated in a predefinable load range, in particular at a predefinable load point. The internal combustion engine is thus operated in a particularly defined, known operating state in which effects which influence the ascertainment of the state of the adjusting device are at least essentially known. The state [of the] adjusting device may thus be ascertained in a particularly precise and meaningful manner. Since the effects for the defined operating state of the internal combustion engine are known, these effects do not result in incorrect measurements or erroneous conclusions.

Further advantages, features, and particulars of the invention result from the following description of one preferred exemplary embodiment and with reference to the drawings. The features and feature combinations stated above in the description, as well as the features and feature combinations stated below in the description of the figures and/or shown in the figures alone, may be used not only in the particular stated combination but also in other combinations or alone without departing from the scope of the invention.

The figures show the following:

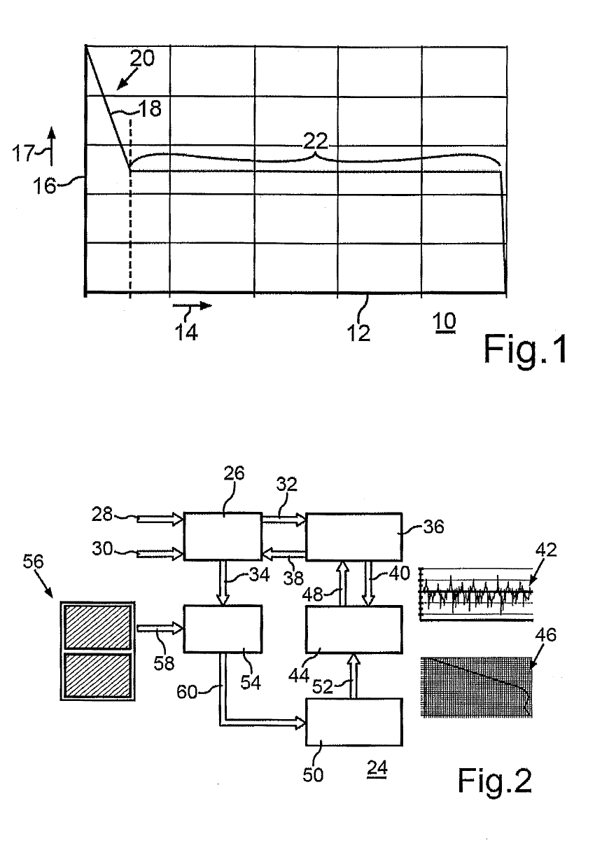

FIG. 1 shows a time curve of a current consumption of an electric motor of an adjusting device for variably setting a compression ratio of an internal combustion engine;

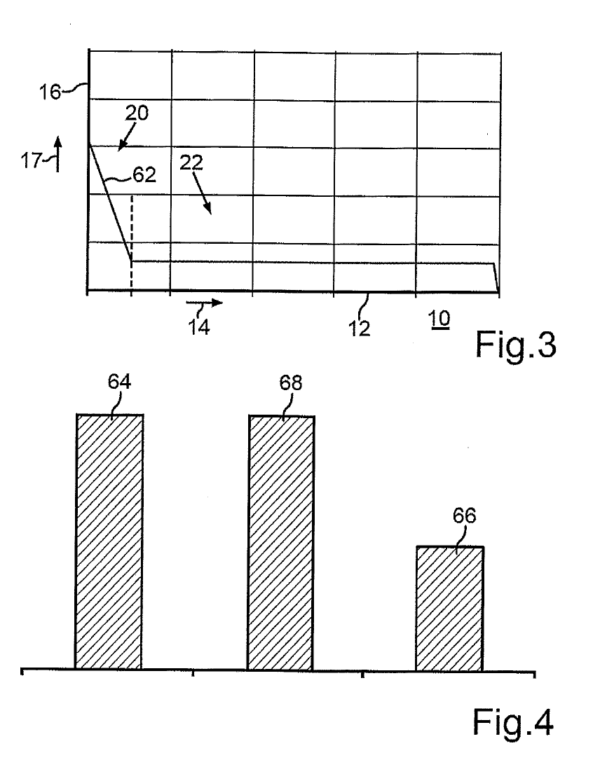

FIG. 2 shows a schematic diagram of a model by means of which physical properties of the internal combustion engine according to FIG. 1 are simulated;

FIG. 3 shows a time curve of a current consumption of the electric motor according to FIG. 1;

FIG. 4 shows a graph for illustrating detected and computed energy quantities which are expended by the electric motor for setting the compression ratio according to FIGS. 1 through 3;

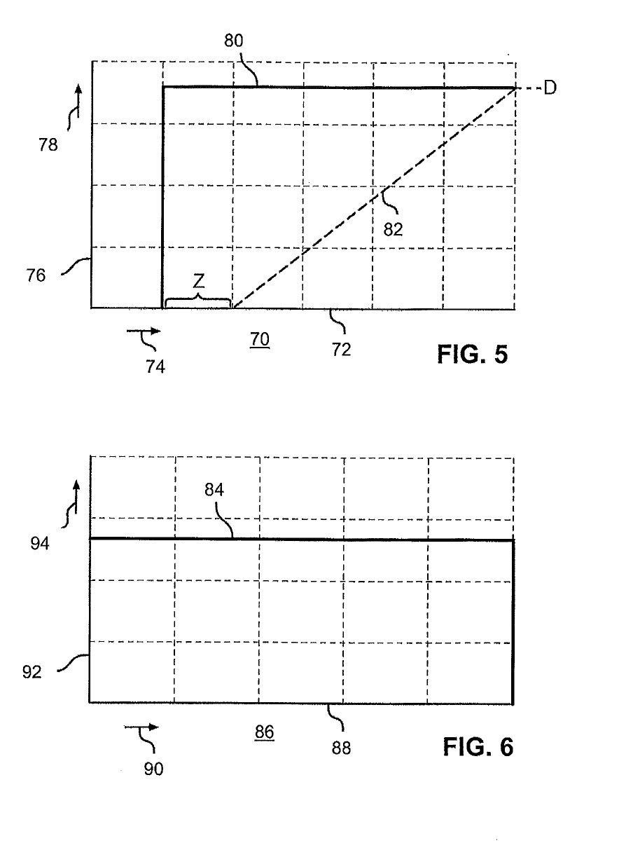

FIG. 5 shows a setpoint time curve and an actual time curve of a rotation angle of an electric motor of an adjusting device for variably setting a compression ratio of an internal combustion engine;

FIG. 6 shows a time curve of an electrical current for checking the adjusting device of the internal combustion engine according to FIG. 1;

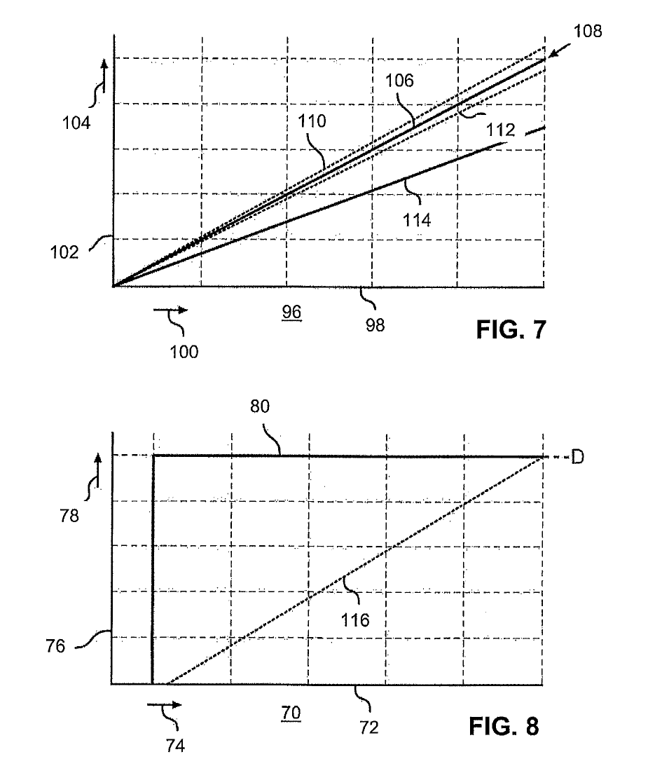

FIG. 7 shows two time curves of a rotary motion of an adjusting shaft of the adjusting device for variably setting the compression ratio of the internal combustion engine, on the basis of which a state of the adjusting device is ascertainable;

FIG. 8 shows a setpoint curve and an actual curve of a rotation angle of an electric motor of the adjusting device for variably setting a compression ratio of the internal combustion engine; and

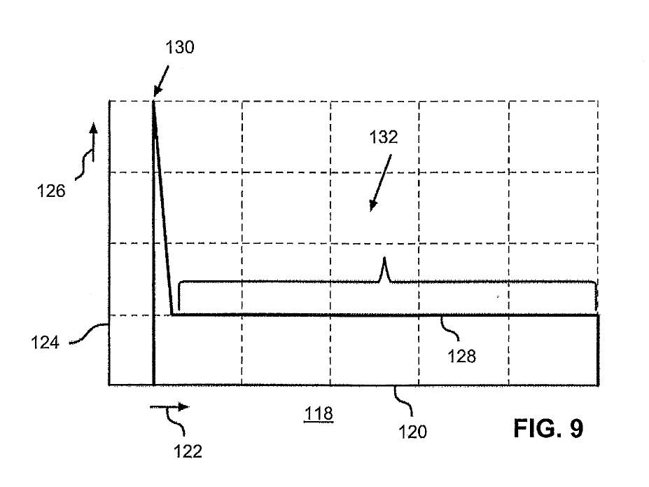

FIG. 9 shows a time curve of an actuating torque to be expended by the adjusting device for variably setting the compression ratio of the internal combustion engine in order to set the compression ratio.

As the result of efforts to reduce fuel consumption in internal combustion engines, internal combustion engines have been provided with at least one variably adjustable compression ratio and with an adjusting device for setting the compression ratio. Such an internal combustion engine is designed as a reciprocating piston machine, for example, and has at least one cylinder in which a corresponding piston is accommodated so as to be translationally movable. For variably setting the compression ratio associated with the cylinder, the adjusting device is provided, by means of which the piston is movable relative to the cylinder inside the cylinder. For this purpose, the adjusting device includes, for example, an electric motor having a rotor which is rotatable about a rotational axis. In addition, the adjusting device includes an adjusting shaft which, for example, is designed as an eccentric shaft and is rotatable about a rotational axis. The eccentric shaft is coupled to the rotor of the electric motor in a rotationally fixed manner, or is coupleable in a rotationally fixed manner for setting or adjusting the compression ratio.

Likewise, it may be provided that an at least essentially linear adjusting shaft and an additional adjusting shaft are provided, which are coupled to one another in a rotationally fixed manner for setting the compression ratio. Thus, the electric motor may introduce a torque onto or into the shaft or shafts for setting the compression ratio. This torque is also referred to as an actuating torque. The actuating torque is transmitted to the piston via the eccentric shaft and/or the adjusting shaft, and further transmission elements of the adjusting device which may be present, so that the piston is moved relative to the combustion chamber inside the combustion chamber. These transmission elements are, for example, a gearing system having at least two gearwheels, each of which have gear teeth. The gear teeth are engaged with one another.

For providing an actuating torque, which is necessary for setting or adjusting the compression ratio, the electric motor has a corresponding current requirement, and thus a corresponding electrical current consumption. Such a current consumption is shown in FIG. 1.

FIG. 1 shows a diagram 10 in which time is continuously plotted on the abscissa 12 according to a directional arrow 14. The electrical current consumption, i.e., the electrical current, of the electric motor is plotted, increasing according to a directional arrow 17, on the ordinate 16 of the diagram 10.

A time curve 18 of the electrical current consumption of the electric motor is plotted in the diagram 10. The curve 18 has a first area 20 and a second area 22. In the first area 20 the adjusting device is in a static friction state. In the second area 22 the adjusting device is in a sliding friction state.

The eccentric shaft and/or the adjusting shaft as well as the further transmission elements of the adjusting device which may be present are each supported on a component, in particular a housing, of the internal combustion engine or of the adjusting device via at least one bearing so as to be rotationally and/or translationally movable. The particular bearing includes at least two bearing parts which are movable relative to one another. If the bearing parts are initially at rest relative to one another, and the bearing parts are transferred into a relative motion with respect to one another, the bearing must be transferred from the static friction state, in which static friction prevails between the bearing parts due to the relative rest, into a sliding friction state, in which sliding friction prevails due to the relative motion of the bearing parts with respect to one another.

For this transfer, actuating forces and/or actuating torques must be applied. Since the static friction, at least in terms of magnitude, is greater than the sliding friction, the actuating forces and/or actuating torques to be expended in the static friction state for transferring the bearing, and thus the adjusting device, from the static friction state into the sliding friction state are greater than in the sliding friction state, in which the bearing parts move relative to one another at least essentially constantly. In the sliding friction state, only essentially constant actuating forces and/or torques are to be expended, in particular to overcome frictional forces and/or frictional torques and to keep the bearing parts in relative motion with respect to one another.

The description concerning the static friction state and the sliding friction state is applicable in particular to slide bearings, which are to be supplied with a lubricant, in particular lubricating oil. This may also be applicable to mutually engaged gear teeth of two gearwheels. The actuating torque for overcoming the static friction or the static friction state is also referred to as breakaway torque.

For the functionality for setting the compression ratio of the adjusting device, it is particularly important that the eccentric shaft (adjusting shaft) of the adjusting device rotates about the rotational axis according to a predefinable setpoint position. The adjusting device may have a plurality of adjusting shafts, in particular which in a torque and/or force flow from the electric motor to the piston and ultimately to the adjusting shafts plays a particularly important role for the functionality of the adjusting device.

Since the actuating torque acts on this adjusting shaft (eccentric shaft), and is at least essentially largely responsible for actuating torques to be expended by the electric motor, the actuating torque to be expended by the electric motor for setting the compression ratio may be used for diagnosis of the adjusting device. In other words, the adjusting device is ascertained with regard to its actual, instantaneously present state as a function of the actuating torque to be applied by the electric motor for setting or adjusting the compression ratio.

For adjusting the compression ratio from a first value, referred to as an epsilon unit, to a second value (epsilon unit) which is different from the first value, a quantity of energy necessary for this purpose must be applied by the adjusting device in order to provide the required actuating torque. This quantity of energy is a function of the epsilon units by which the compression ratio is adjusted, as well as a function of a load and/or a speed of the internal combustion engine. The load and/or the speed and the epsilon units to be adjusted influence, at least in terms of magnitude, the actuating torque to be expended; a corresponding quantity of energy is necessary for expending or applying this actuating torque. This quantity of energy which is necessary for setting or adjusting the compression ratio may on the one hand be measured via the current consumption of the electric motor, as illustrated with reference to the curve 18 in FIG. 1.

On the other hand, it is possible, based on a real-time simulation model by means of which at least one physical property of the internal combustion engine having the adjusting device is simulated, to compute a quantity of energy which is to be expended for setting or adjusting the compression ratio. The epsilon units to be adjusted, as well as the load and/or the speed of the internal combustion engine, are used as input variables of the simulation model.

FIG. 2 shows such a simulation model 24, by means of which the quantity of energy to be expended is to be computed as the setpoint energy quantity. Within the scope of the simulation model 24, the eccentric shaft is modeled by a simulation block 26. A directional arrow 28 represents an input variable of the simulation model. The input variable indicated by the directional arrow 28 is the load M_{engine} of the internal combustion engine. In addition, a further input variable of the simulation model 24, which is the instantaneously set compression ratio Eps_{actual}, is indicated by a directional arrow 30. Further input variables of the simulation model 24 may be a variation of torque over time M_{eccentric} on the eccentric shaft, which is illustrated by a directional arrow 32. A further input variable may be an actual angular position α_{actual} of the eccentric shaft, which represents the instantaneous angular position of the eccentric shaft. This input variable is represented by a directional arrow 34. Further transmission elements, such as at least one gearing system of the adjusting device, are modeled by a simulation block 36 of the simulation model 24.

A gear ratio and/or a type of gearing and/or inertias and/or elasticities of the transmission elements are modeled by the simulation block 36. The simulation block 36 receives the input variable illustrated by the directional arrow 32. One output variable of the simulation block 36, indicated by a directional arrow 38, is a rotational speed n_{eccentric} of the eccentric shaft which is supplied to the simulation block 36. A further output variable of the simulation block 36 is a torque M_{adjusting shaft} on the adjusting shaft. This output variable is illustrated by a directional arrow 40. The modeling of the adjusting shaft is schematically illustrated in FIG. 2 and denoted by reference numeral 42. A variation of torque over time at the adjusting shaft and/or an adjustment angle at the adjusting shaft is/are modeled.

The output variable of the simulation block 36, illustrated by the directional arrow 40, is supplied to a simulation block 44 of the simulation model 24. The electric motor is modeled by the simulation block 44. This modeling of the electric motor is schematically illustrated in FIG. 2 and denoted by reference numeral 46. A torque characteristic curve and/or a dynamics requirement of the electric motor is/are modeled. A directional arrow 48 represents an output variable of the simulation block 44. This output variable is a speed n_{electric motor} of the electric motor, which is supplied to the simulation block 36.

An output stage of a power electronics system of the adjusting device is modeled by a further simulation block 50. An output variable of the simulation block 50, indicated by a directional arrow 52, is an electrical power P_{electrical} by means of which the current consumption of the electric motor is characterized.

The simulation model 24 also has a further simulation block 54 by means of which a regulator for regulating the adjusting device, and thus the setting of the compression ratio, is modeled. This modeling is schematically illustrated in FIG. 2 and denoted by reference numeral 56. A position control of the adjustment angle of the eccentric shaft and/or a sensor resolution is/are modeled.

An input variable of the simulation block 54 is represented by a directional arrow 58. This input variable is a setpoint compression ratio which is to be set and which is to be present after setting the compression ratio. An output variable of the simulation block 54 is illustrated by a directional arrow 60. This output variable is a setpoint rotation angle αₛₑₜₚₒᵢₙₜ by which the adjusting shaft is to be rotated for setting the compression ratio.

The directional arrows 30, 34, 58, and 60 indicate an information flow, while the remaining directional arrows 28, 32, 38, 40, 48, and 52 indicate an energy flow. Thus, based on the simulation model 24, the quantity of energy to be applied by the adjusting device in order to adjust the compression ratio from a given value to a different value is to be computed as the setpoint energy quantity.

FIG. 3 shows the diagram 10, in which a further time curve 62 of the current consumption of the electric motor is plotted. The curve 62 is measured in the same way as the curve 18, and characterizes the quantity of energy as the actual energy quantity which is or has been actually expended by the adjusting device in order to adjust the compression ratio from the first value to the second, different value.

As is apparent from a comparison with FIG. 1, the curve 62 is lower than the curve 18 in terms of magnitude. In other words, this means that in a measuring operation for measuring the curve 62, the adjusting device has applied or used a smaller actual quantity of energy for setting the compression ratio than in some other measuring operation in which the curve 18 is or has been detected.

FIG. 4 shows an energy bar 64 which characterizes the actual energy quantity which is ascertained based on the measured curve 18. FIG. 4 also shows an energy bar 66 which characterizes the actual energy quantity which is ascertained based on the measured curve 62. FIG. 4 also shows a further energy bar 68 which characterizes the setpoint energy quantity which is computed based on the simulation model 24. The setpoint energy quantity represents the quantity of energy to be expended for an adjusting device, which is fully functional and at least essentially free of wear, in order to set the compression ratio.

A comparison of the energy bar 64 to the energy bar 68, and thus a comparison of the actual energy quantity ascertained based on the curve 18 to the setpoint energy quantity ascertained based on the simulation model 24, allows the conclusion that during the measuring operation for setting the curve 18, the adjusting device is or was at least essentially fully functional, has little or no wear, and is able to meet its function of setting the compression ratio. This is the case, since the actual energy quantity characterized by the energy bar 64 at least essentially matches the setpoint energy quantity characterized by the energy bar 68.

In contrast, a comparison of the energy bar 66 to the energy bar 68, and thus a comparison of the actual energy quantity ascertained based on the curve 62 to the setpoint energy quantity ascertained based on the simulation model 24, shows that when the measuring operation for detecting the curve 62 is carried out, the adjusting device has a different state than that modeled by the simulation model 24. Since the actual energy quantity characterized by the energy bar 66 is significantly less than the setpoint energy quantity characterized by the energy bar 68, on the basis of this comparison it may be concluded that the eccentric shaft and/or the adjusting shaft and/or at least one of the transmission elements, such as the gearing, has failed, i.e., cannot meet its function for setting the compression ratio in the desired manner.

Thus, based on the comparison of the actual energy quantity to the setpoint energy quantity, the state and the functionality of the adjusting device, and in particular of its transmission elements, may be ascertained in a particularly precise and meaningful manner. In the event of a failure of one of the transmission elements, in particular the last adjusting shaft of the adjusting device is not rotated. As is apparent from a comparison of FIG. 1 to FIG. 3, the actuating torques on the adjusting shaft are thus absent. This reduces a load on the electric motor to be rotated, so that the electric motor has a lower current consumption in comparison to the simulation model 24 and to the curve 18, in which the transmission elements are intact.

It is also desirable to ascertain the state of the adjusting device, in particular with regard to its wear, in a precise and meaningful manner. With reference to FIGS. 5 through 7, a method is illustrated by means of which the state of the adjusting device may be ascertained in a particularly meaningful and precise manner.

The electric motor is initially operated with position control; i.e., the electric motor is operated in such a way that its rotor, and thus the adjusting shaft coupled via a transmission device, undergoes a predefined movement. The predefined movement involves a rotation angle of the adjusting shaft. In other words, the electric motor is operated for a period of time and in such a way that and until its rotor, and thus the adjusting shaft coupled via a transmission device, has covered the predefinable rotation angle, starting from a rotating position.

For illustrating this position-controlled operation, FIG. 5 shows a diagram 70 on which time is continuously plotted on the abscissa 72 according to a directional arrow 74. The rotation angle of the rotor of the electric motor, and thus of the adjusting shaft, is plotted, increasing according to a directional arrow 78, on the ordinate of the diagram 70.

A setpoint curve 80 of the rotation angle is plotted in the diagram 70. The setpoint curve 80 characterizes the rotary motion of the engine, and thus of the adjusting shaft during operation of the electric motor, when the adjusting device ideally is or would be free of friction.

In fact, however, signs of friction appear during operation of the adjusting device for setting the compression ratio. Thus, the electric motor is operated with position control, and for example at least one complete revolution of the rotor, and thus of the adjusting shaft, is carried out in order to overcome a so-called breakaway torque of the adjusting device. The breakaway torque characterizes the torque to be expended by the electric motor in order to transfer the adjusting device from a static friction state, in which static friction is present, into a sliding friction state in which sliding friction is present.

Starting from two parts which are movable relative to one another, for example two bearing parts of the bearing of the adjusting shaft, which are initially at rest relative to one another, initially the static friction state and thus the static friction must be overcome in order to set the parts, i.e., the bearing parts, in relative motion with respect to one another. Since the static friction, at least in terms of magnitude, is greater than the sliding friction, for overcoming the static friction state a higher actuating force or a higher actuating torque (breakaway torque) must be applied than in the sliding friction state in order to keep the parts in relative motion with respect to one another. In the sliding friction state, the actuating torque to be expended for the relative motion of the parts is determined at least essentially solely by frictional forces between the parts. If the static friction state is overcome, in the sliding friction state only an at least essentially constant actuating force or an at least essentially constant actuating torque is necessary to keep the parts in relative motion with respect to one another. This is applicable in particular to slide bearings, which are to be lubricated with a lubricant, in particular lubricating oil.

Due to the necessity of initially overcoming the breakaway torque in order to move the adjusting shaft from a resting state into a rotating state, an actual curve of the rotation angle shown in FIG. 5 deviates from the ideal setpoint curve 80. The diagram 70 shows a time period Z which lasts for the amount of time for overcoming the breakaway torque. As a result, the rotor and thus the adjusting shaft which is coupled via a transmission device are then moved with position control until they have a desired setpoint rotation angle D. This setpoint rotation angle D is at least essentially 360°, for example, so that at least one complete revolution of the rotor is carried out.

The electric motor is supplied with electrical current for operating the electric motor, and thus for rotating the rotor and the adjusting shaft which is coupled via a transmission device. The current supplied to the electric motor is proportional to the actuating torque which is expended by the electric motor and transmitted to the adjusting shaft. The electrical current to be expended for overcoming the breakaway torque may likewise be used for assessing the state of the adjusting device. The higher the current to be expended for overcoming the breakaway torque, the higher the frictions that are present in the adjusting device. This indicates a relatively high level of wear of the adjusting device.

This current, which is necessary for overcoming the breakaway torque, may be compared to a stored current which is stored in a characteristic map, for example. The stored current characterizes the adjusting device in a state in which it has at least essentially little or no friction or wear. If the stored current is less than the current that is necessary for overcoming the breakaway torque, this indicates increased wear of the adjusting device. After carrying out the predeterminable, defined motion of the rotor in the form of the predefinable setpoint rotation angle D of at least essentially 360°, the electric motor is actuated and operated with a predeterminable, defined current curve 84 shown in FIG. 6. Thus, a predefinable motion of the adjusting shaft (and thus also of the rotor) is carried out in this method.

FIG. 6 shows a diagram 86 in which time is continuously plotted on the abscissa 88 according to a directional arrow 90. The electrical current with which the electric motor is operated for adjusting or setting the compression ratio is plotted, increasing according to a directional arrow 94, on the ordinate 92 of the diagram 86.

The method for ascertaining the state of the adjusting device is carried out, for example, in a defined state of the internal combustion engine. This defined state is, for example, an overrun mode of a control unit for controlling and/or regulating the internal combustion engine. In this overrun mode the control unit is operated after a deactivation of the internal combustion engine is triggered, the internal combustion engine being deactivated. However, the control unit is not yet deactivated. In this deactivated state of the internal combustion engine, no combustion processes take place in combustion chambers, in particular cylinders, of the internal combustion engine. Therefore, no additional torques and/or forces due to the combustion processes and/or due to a rotation of a crankshaft act on the adjusting shaft. At least essentially only moments of inertia and/or inertial forces of the adjusting device as well as increased frictional torques due to wear of the adjusting device act on the adjusting shaft.

After the breakaway torque, which prevails due to the static friction force, is overcome, an actuating torque results which is at least essentially proportional to the current, and thus to the current curve 84.

As a function of frictional forces in particular in the at least one bearing, of gear tooth forces of gearwheels of the adjusting device, and/or of other forces, the rotor, and thus the adjusting shaft which is coupled via a transmission device, undergo a number of revolutions; i.e., the rotor and the adjusting shaft which is coupled via a transmission device move over a certain rotation angle also as a function of the level, i.e., the magnitude, and the duration of the current (current curve 84).

If the adjusting device has a state with relatively low wear and thus relatively low friction, the rotor and the adjusting shaft which is coupled via a transmission device undergo a relatively large number of revolutions; i.e., the rotor and the adjusting shaft which is coupled via a transmission device move over a relatively large rotation angle. On the other hand, if the adjusting device has a state with greater wear and thus greater friction, the rotor and the adjusting shaft which is coupled via a transmission device undergo a fewer number of revolutions; i.e., the rotor and the adjusting shaft which is coupled via a transmission device move over a smaller rotation angle.

The detected number of revolutions and/or the detected rotation angle in each case thus represent(s) a measured variable on the basis of which the state of the adjusting device, and thus the presence of a certain, relatively high level of wear and a certain, relatively high level of friction, may be deduced. A measurement, evaluation, and diagnosis of a kinematic variable of the adjusting device may thus be carried out in a simple and cost-effective manner. No additional sensors and/or actuators are needed. This keeps the weight, the installation space requirements, and the costs of the internal combustion engine low.

The resulting rotation angle of the rotor or of the adjusting shaft may be detected by means of an appropriate detection device and compared to a setpoint rotation angle stored in a memory device.

FIG. 7 shows a diagram 96 in which time is continuously plotted on the abscissa 98 according to a directional arrow 100. The rotation angle is plotted, increasing according to a directional arrow 104, on the ordinate 102 of the diagram 96. An actual curve 106 of a detected rotation angle of the rotor, and thus of the adjusting shaft, is plotted in the diagram 96. The actual curve 106 characterizes a state of the adjusting device in which the adjusting device has relatively low wear. A tolerance band 108 which is delimited by an upper threshold curve 110 and a lower threshold curve 112 is also plotted in the diagram 96. If a detected curve of the rotation angle is within the tolerance band 108 or at least on the threshold curves 110 or 112, the adjusting device still has an advantageous state in which the adjusting device is able to meet high adjustment dynamics and precisely set the compression ratio.

A further actual curve 114 of the detected rotation angle is plotted in the diagram 96. As is apparent from FIG. 7, the actual curve 114 is situated outside the tolerance band 108. The actual curve 114 indicates an increased and possibly undesirably high level of wear of the adjusting device with increased frictions. If the actual curve 114 is detected, appropriate countermeasures may be initiated early in order to service the adjusting device and return it to an advantageous, desirable state which is characterized by the actual curve 46, for example.

With reference to FIGS. 8 and 9, a further method is illustrated by means of which the state of the adjusting device may additionally or alternatively be ascertained in a particularly precise and meaningful manner. The electric motor is actuated with position control at a defined, predefinable rotational speed. This means that the electric motor is operated in such a way that it undergoes a predefinable movement in the form of the rotational speed. Likewise, it may be provided that the electric motor is operated in such a way that the rotor, and thus the adjusting shaft which is coupled via a transmission device, undergo a predeterminable, defined rotation angle D. In other words, the electric motor is supplied with a high enough current in terms of magnitude, over a sufficiently long time period, until the rotor, and thus the adjusting shaft which is coupled via a transmission device, have covered the predefinable rotation angle D.

FIG. 8 shows the diagram 70 with the ideal setpoint curve 80. The actual curve 116 is once again plotted in the diagram 70. As is apparent from FIG. 8, the electric motor is operated until the actual curve 116 has reached the predefinable setpoint rotation angle D of the setpoint curve 80. A necessary current to be expended for carrying out this predeterminable defined movement (rotational speed and/or setpoint rotation angle D) is measured using an appropriate detection device. This provides the option for detecting the magnitude of the current for overcoming the breakaway torque, and subsequently, the magnitude of the current for adjusting or setting the compression ratio at the defined rotational speed. Since, as described, the current is proportional to the actuating torque, the actuating torque may thus also be detected or ascertained. This is illustrated with reference to FIG. 9.

FIG. 9 shows a diagram 118 in which time is continuously plotted on the abscissa 120 according to a directional arrow 122. The actuating torque is plotted, increasing according to a directional arrow 126, on the ordinate of the diagram 118. A curve 128 of the actuating torque is plotted in the diagram 118. The curve has a first area 130 which characterizes the static friction state. Thus, in the area 130 the curve 128 characterizes the breakaway torque which is to be applied in order to transfer the adjusting device from the static friction state into the sliding friction state.

The curve 128 has a second area 132 which characterizes the sliding friction state of the adjusting device. In the sliding friction state the actuating torque has an at least essentially constant curve. Based on the curve 128, the actuating torque on a current or its current time curve may be ascertained in a particularly precise manner in the area 132 of the curve 128. Thus, the state of the adjusting device may be ascertained in a particularly precise and meaningful manner.

Another option for ascertaining the state of the adjusting device is to operate the electric motor with position control at a maximum allowable current level. This means that the maximum allowable current is supplied to the electric motor. This results in a maximum rotational speed of the stator, and thus of the adjusting shaft. The maximum resulting rotational speed allows the state of the adjusting system to be assessed. The lower the friction and the wear of the adjusting device, the higher the resulting maximum rotational speed, and vice versa. This resulting maximum rotational speed is referred to as the limiting speed. An actuating torque required in this state of the adjusting device may be associated with the limiting speed via a rotational speed-torque characteristic curve of the electric motor, so that particularly precise and meaningful conclusions regarding the adjusting device may be drawn.

The methods illustrated with reference to FIGS. 5 through 9 are preferably carried out when the internal combustion engine is in an unfired and nondriven operating state. As a result, the ascertainment of the state of the adjusting device is not affected by influences, such as forces and/or torques, resulting from the combustion. In addition, the ascertainment of the state of the adjusting device is not influenced by the piston, which moves relative to the combustion chamber inside the combustion chamber. The instantaneous, actually present state of the adjusting device may thus be ascertained in a particularly precise and meaningful manner. In particular, no additional torque due to combustion processes or due to a rotation of the crankshaft acts on the adjusting shaft.

However, the methods described and illustrated with reference to FIGS. 5 through 9 may also preferably be carried out when the internal combustion engine is operated in a fired operating state. The methods are thus carried out at a defined operating point of the internal combustion engine. In this defined operating state, no additional defined, known torque and/or no additional defined, known force due to combustion processes in the cylinder and due to a rotation of the crankshaft act(s). This defined torque and/or this defined force act(s) on the adjusting shaft.

A defined load point of the internal combustion engine together with the corresponding actuating torque are stored in a memory device of the control unit of the internal combustion engine. It may thus be provided that the methods are carried out when the internal combustion engine is in idle mode and/or at other defined load points of the internal combustion engine. In particular, the methods may also be carried out as a function of at least one predefinable temperature of a lubricant, in particular lubricating oil, for lubricating the adjusting device and/or the internal combustion engine. Additionally or alternatively, it is possible to carry out the methods as a function of at least one temperature of a cooling medium, in particular a cooling fluid, for cooling the adjusting device and/or the internal combustion engine. This means that the methods are carried out when the at least one temperature (of the lubricant and/or of the cooling medium) is not above or below at least one predefinable threshold value. Likewise, it may be provided that the methods are carried out when the at least one temperature is within a predefinable temperature range.

It is thus apparent that the methods are carried out in defined, known operating states of the internal combustion engine and in particular of the adjusting device. This means that the methods are carried out when defined, known conditions are present. Thus, effects which may possibly influence the ascertainment of the state of the adjusting device are known. These effects are then not able to adversely affect the ascertainment of the state of the adjusting device, so that the state of the adjusting device may be ascertained in a particularly precise and meaningful manner, and at least essentially without measurement errors.

1. An internal combustion engine for a motor vehicle, having at least one adjusting device by means of which at least one compression ratio of the internal combustion engine is variably settable, wherein at least one detection device is provided via which at least one signal (20, 22) which characterizes an actuation effort or an actual energy quantity for setting the compression ratio is detectable.

2. The internal combustion engine according to claim 1, wherein at least one computing unit is provided via which the actual energy quantity is ascertainable based on the detected signal (18, 62), via which a setpoint energy quantity to be expended for setting the compression ratio is computable based on a model (24) which simulates at least one physical property of the internal combustion engine, and the signal (20, 22) which is detected via the detection device may be compared to a predefinable setpoint value, setpoint signal (20, 26), or the like and a state of the adjusting device is ascertainable.

3. The internal combustion engine according to claim 1, wherein via the detection device, at least one torque and/or at least one variation of torque over time (20, 22), and/or at least one force and/or at least one variation of force over time, is/are detectable as the signal (20, 22) which characterizes the actuation effort for setting the compression ratio.

4. The internal combustion engine according to claim 1, wherein the adjusting device includes at least one electric motor for setting the compression ratio, whereby an electrical current consumption (18, 62) of the electric motor is detectable by means of the detection device as the signal (18, 62) which characterizes the actual energy quantity to be expended for setting the compression ratio, and the setpoint energy quantity to be expended for setting the compression ratio as a function of an electrical current consumption of the electric motor, computed based on the model (24), is computable by means of the computing unit.

5. A method for checking an adjusting device having an adjusting element for variably setting at least one compression ratio of an internal combustion engine for a motor vehicle, in which a state of the adjusting device is ascertained,
characterized by the following steps:
detecting and ascertaining a characterizing actual signal (18, 62, 82, 106, 114, 116) by means of at least one detection device and at least one computing unit,
computing a setpoint signal (80) to be used for setting the compression ratio, based on a model (24) which simulates at least one physical property of the internal combustion engine, and
comparing the actual signal to the setpoint signal, the state of the adjusting device being ascertained based on this comparison.

6. The method according to claim 5, wherein a quantity of energy of the adjusting element to be expended for setting the compression ratio is detected as the signal (82, 106, 114, 116).

7. The method according to claim 5, wherein a signal which characterizes a rotary motion of the adjusting element about a corresponding rotational axis due to supplying the adjusting device with the predefinable quantity of energy is detected as the signal (82, 106, 114, 116).

8. The method according to claim 5, wherein a time curve (20, 80) of a variable of the adjusting element which characterizes the actuation effort for setting the compression ratio is detected as the signal (20, 80).

9. The method according to claim 5, wherein a time curve (18, 62) of an electrical current consumption of an electric motor associated with the adjusting device for setting the compression ratio is detected as the signal (18, 62).

10. The method according to claim 5, wherein the time curve (20, 132) is divided into a first range (18, 62, 130) which characterizes a static friction state of the adjusting device, and at least one second range (22, 128) which characterizes a sliding friction state of the adjusting device.

11. The method according to claim 5, wherein a failure of at least one force and/or torque transmission element associated with the adjusting device for setting the compression ratio is ascertained when the actual energy quantity is less than the setpoint energy quantity.

12. The method according to claim 5, wherein the method is carried out after a deactivation of the activated internal combustion engine is triggered.

13. The method according to claim 5, wherein the method is carried out when the internal combustion engine is in an unfired operating state.

14. The method according to claim 13, wherein the method is carried out when the internal combustion engine is in a nondriven operating state and/or when a travel speed of the motor vehicle is less than a predefinable threshold value, or the motor vehicle is at a standstill.

15. The method according to claim 13, wherein the method is carried out for a predefinable trigger event.

16. The method according to claim 5, wherein the internal combustion engine is in a fired operating state.

17. The method according to claim 16, wherein the method is carried out when the internal combustion engine is operated in a predefinable speed range.

18. The method according to claim 17, wherein the method is carried out when the internal combustion engine is operated in a predefinable load range or at least essentially at a certain load.

19. The internal combustion engine according to claim 2, wherein the state, of the adjusting device being ascertained is a wear state.

20. The method according to claim 7, wherein the signal which characterizes a rotary motion is a rotation angle (D) and/or a rotational speed of the adjusting element about a corresponding rotational axis.
